(19) United States
(12) Patent Application Publication
(10) Pub. No.: US 2025/0056283 A1
(43) Pub. Date: Feb. 13, 2025

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 18/717,803

(22) PCT Filed: Dec. 13, 2021
(86) PCT No.: PCT/CN2021/137577

§ 371 Date: Jun. 7, 2024

(51) Int. Cl. H04W 24/10; H04W 84/12

(52) U.S. Cl. CPC H04W 24/10; H04W 84/12

(57) ABSTRACT

A communication method is performed by an initiator of sensing in wireless local area network. The method includes: determining first time information, wherein the first time information is configured to indicate a feedback occasion of a measurement report for at least one measurement exchange; and sending the first time information during a wireless local area network sensing measurement setup procedure.

### CROSS REFERENCE TO RELATED APPLICATION

The present application is a U.S. National Stage of International Application No. PCT/CN2021/137577, filed on Dec. 13, 2021, the contents of which are incorporated herein by reference.

### TECHNICAL FIELD

Embodiments of the present disclosure relate to the mobile communication technical field. Specifically, embodiments of the present disclosure relate to a communication method and apparatus, a device and a storage medium.

### BACKGROUND

Wireless Local Area Network (WLAN) has the characteristics of flexibility, mobility and low cost. With the developments of communication technologies and the growth of user demands, research on the application of WLAN, such as wireless local area network sensing, is gradually deepening.

### SUMMARY

Embodiments of the present disclosure provide a communication method and apparatus, a device and a storage medium.

According to a first aspect, an embodiment of the present disclosure provides a communication method. The method may be applied to an initiator of sensing in wireless local area network. The method includes:
determining first time information, wherein the first time information is configured to indicate a feedback occasion of a measurement report for at least one measurement exchange; and
sending the first time information during a wireless local area network sensing measurement setup procedure.

According to a second aspect, an embodiment of the present disclosure provides a communication method. The method may be applied to a responder of sensing in wireless local area network. The method includes:
receiving first time information during a wireless local area network sensing measurement setup procedure, wherein the first time information is configured to indicate a feedback occasion of a measurement report for at least one measurement exchange; and
based on the feedback occasion, feeding back the measurement report for respective measurement exchange.

According to a third aspect, an embodiment of the present disclosure further provides a communication apparatus. The apparatus includes:
a determination unit configured to determine first time information, wherein the first time information is configured to indicate a feedback occasion of a measurement report for at least one measurement exchange; and
a sending unit configured to send the first time information during a wireless local area network sensing measurement setup procedure.

According to a fourth aspect, an embodiment of the present disclosure further provides a communication apparatus. The apparatus includes:
a receiving unit configured to receive first time information during a wireless local area network sensing measurement setup procedure, wherein the first time information is configured to indicate a feedback occasion of a measurement report for at least one measurement exchange; and
a feedback unit configured to, based on the feedback occasion, feed back the measurement report for respective measurement exchange.

According to a fifth aspect, an embodiment of the present disclosure further provides an initiator of sensing in wireless local area network, wherein the initiator includes a memory, a processor and a computer program stored in the memory and executable on the processor, and when the program is executed by the processor, the communication method provided by the first aspect of the embodiment of the present disclosure is implemented.

According to a sixth aspect, an embodiment of the present disclosure further provides a responder of sensing in wireless local area network, wherein the responder includes a memory, a processor and a computer program stored in the memory and executable on the processor, and when the program is executed by the processor, communication the method provided by the second aspect of the embodiment of the present disclosure is implemented.

According to a seventh aspect, an embodiment of the present disclosure further provides a computer-readable storage medium, wherein a computer program is stored on the computer-readable storage medium, and when the computer program is executed by a processor, the communication method provided by any one of the embodiments of the present disclosure is implemented.

Additional aspects and advantages of the embodiments of the present disclosure will be partially given in the description below, which will become apparent from the description below, or will be learned through the practice of the present disclosure.

### BRIEF DESCRIPTION OF THE DRAWINGS

The accompanying drawings of the present disclosure will be briefly introduced below. Obviously, the drawings in the following description are only example embodiments of the present disclosure.

FIG. 1 is a flowchart of a communication method provided by an embodiment of the present disclosure;

FIG. 2 is another flowchart of a communication method provided by an embodiment of the present disclosure:

FIG. 3 is a schematic structural diagram of a communication apparatus provided by an embodiment of the present disclosure:

FIG. 4 is another schematic structural diagram of a communication apparatus provided by an embodiment of the present disclosure:

FIG. 5 is a schematic structural diagram of an initiator of sensing in wireless local area network provided by an embodiment of the present disclosure:

FIG. 6 is a schematic structural diagram of a responder of sensing in wireless local area network provided in an embodiment of the present disclosure.

### DETAILED DESCRIPTION

In the embodiments of the present disclosure, the term “and/or” describes an association relationship of associated objects, indicating that three relationships may exist. For example, A and/or B may represent three situations: A alone, B alone, and A and B together. The character “/” generally indicates that associated objects before and after “/” are in an “or” relationship.

The term “a plurality of” in the embodiments of the present disclosure refers to two or more than two, and other quantifiers are similar thereto.

Exemplary embodiments will be described in detail herein, examples of which are illustrated in the accompanying drawings. When the following description refers to the drawings, the same numbers in different drawings refer to the same or similar elements, unless otherwise indicated. The implementations described in the following exemplary embodiments do not represent all implementations consistent with the present disclosure. Rather, they are merely examples of apparatus and methods consistent with some aspects of the present disclosure as described in the appended claims.

The terminologies used in this disclosure are for the purpose of describing example embodiments only and are not intended to be limiting of the present disclosure. As used in the present disclosure and the appended claims, the singular forms “a/an”, “the” and “said” are intended to include plural forms as well, unless the context clearly dictates otherwise. It will also be understood that the term “and/or” as used herein refers to and includes any and all possible combinations of one or more of associated listed items.

It should be understood that although the terms first, second, third, etc. may be used in the present disclosure to describe various information, such information should not be limited to these terms. These terms are only configured to distinguish information of the same type from each other. For example, without departing from the scope of the present disclosure, first information may also be referred to as second information, and similarly, second information may also be referred to as first information. Depending on the context, the word “if” as used herein may be interpreted as “when” or “upon” or “in response to determining . . . ”.

The technical solutions in the embodiments of the present disclosure will be described clearly and fully in combination with drawings in the embodiments of the present disclosure. Obviously, the described embodiments are only part of the embodiments of the present disclosure, not all of the embodiments. Based on the embodiments in the present disclosure, all other embodiments obtained by those of ordinary skill in this art without making creative work fall within the scope of protection of the present disclosure.

In wireless local area network sensing measurement, a responder of sensing in wireless local area network may feed back a measurement report for a measurement exchange during the sensing measurement procedure. However, it is still unclear how to indicate a feedback occasion of the measurement report for the measurement exchange.

In an embodiment of the present disclosure, the process of wireless local area network sensing may be as follows. An initiator initiates wireless local area network sensing (for example, initiates a wireless local area network sensing measurement session), and there may be a plurality of responders responding to it.

The initiator of sensing in wireless local area network and the responder of sensing in wireless local area network may include but are not limited to: a cellular phone, a smart phone, a wearable device, a computer, a Personal Digital Assistant (PDA), a Personal Communication System (PCS) device, Personal Information Management (PIM), Personal Navigation Device (PND), a global positioning system, a multimedia device, an Internet of Things (IoT) device, etc.

For convenience of description, the initiator of sensing in wireless local area network is called an initiator and the responder of sensing in wireless local area network is called a responder.

For example, a client serves as an initiator to initiate wireless local area network sensing, and a plurality of associated or non-associated sensing responders (for example, three access points (APs)) may respond. The “associated” here may mean that an associated connection for communication has been established between the initiator and the responder, and “non-associated” may mean that no associated connection for communication has been established between the initiator and the responder.

An AP is a wireless switch used in a wireless network and is also an access device of a wireless network. An AP may include a software application and/or a circuit to enable other types of nodes in the wireless network to communicate with outside and inside of the wireless network through the AP. As an example, the AP may be a terminal device or a network device equipped with a Wireless Fidelity (Wi-Fi) chip.

The plurality of responders may communicate with each other. For example, both the initiator and the responder may be clients, and both may perform communication by connecting to the same AP.

Although in the above description, the client serves as the initiator and the AP serves as the responder, the present disclosure is not limited thereto. For example, the AP may serve as the initiator and the client may serve as the responder. In addition, there is no limit on the number of initiator s and responders.

Embodiments of the present disclosure provide a communication method and apparatus, a device, and a storage medium for enabling an initiator of sensing in wireless local area network to indicate a feedback occasion of a measurement report for at least one measurement exchange during a wireless local area network sensing measurement setup procedure.

The method and the apparatus are based on the same disclosed concept. Since the principles for the method and the device to solve problem(s) are similar, the implementation of the device and the method can be referred to each other, and the details will not be repeated.

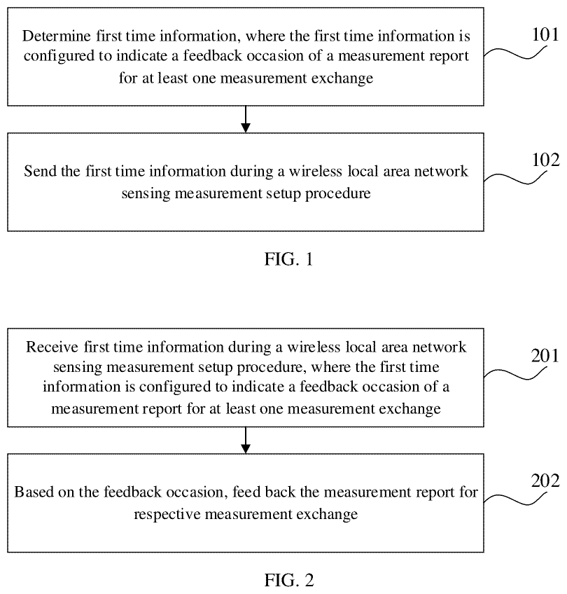

As shown in FIG. 1, an embodiment of the present disclosure provides a communication method. Optionally, the method may be applied to an initiator of sensing in wireless local area network. The communication method shown in FIG. 1 may specifically include the following steps:

In step 101, first time information is determined. The first time information is configured to indicate a feedback occasion of a measurement report for at least one measurement exchange.

Specifically, the first time information may be determined before a wireless local area network sensing measurement procedure, for example, may be determined during a wireless local area network sensing measurement setup procedure.

The first time information may be configured to indicate a delayed feedback occasion of the measurement report for at least one measurement exchange. For example, the first time information may indicate that the responder of sensing in wireless local area network feeds back the measurement report for at least one measurement exchange at any time after receiving a Null Data Packet (NDP) frame corresponding to the at least one measurement exchange.

The first time information may simultaneously indicate the feedback occasions of measurement reports for a plurality of measurement exchanges, so that the responder of sensing in wireless local area network may feed back a corresponding measurement report based on the feedback occasion of the measurement report for each measurement exchange. Alternatively, the responder of sensing in wireless local area network may perform an aggregated feedback of measurement reports for a plurality of measurement exchanges at a feedback occasion. That is, the responder of sensing in wireless local area network sends aggregated feedback information, and the aggregated feedback information includes an exchange identity of each measurement exchange and its corresponding measurement report.

The measurement report for each measurement exchange may be Channel State Information (CSI) or Channel Quality Information (CQI), which is not limited here.

The first time information may indicate the feedback occasion of the measurement report for one measurement exchange. Specifically, the first time information may include an exchange identity of a certain measurement exchange to indicate the responder of sensing in wireless local area network to send a measurement report for the measurement exchange after completing measurement of one measurement exchange after the measurement exchange, and at the same time, the initiator of sensing in wireless local area network may receive the measurement report for the measurement exchange after completing the measurement of a next measurement exchange after the measurement exchange.

In this case, the responder of sensing in wireless local area network may send a plurality of pieces of time information to indicate feedback occasions of measurement reports for different measurement exchanges.

In step 102, the first time information is sent during a wireless local area network sensing measurement setup procedure.

Embodiments of the present disclosure can enable an initiator of sensing in wireless local area network to indicate a feedback occasion of a measurement report for at least one measurement exchange during a wireless local area network sensing measurement setup procedure. Thus, a responder of sensing in wireless local area network can feed back a measurement report for a corresponding measurement exchange at a corresponding feedback occasion.

Specifically, the initiator of sensing in wireless local area network may send the first time information at any time before the wireless local area network sensing measurement procedure, for example, sending the first time information during a wireless local area network sensing measurement setup procedure.

In an optional embodiment, when a wireless local area network sensing measurement session initiated by an initiator of sensing in wireless local area network corresponds to one transmission opportunity, that is, when a measurement exchange corresponding to the wireless local area network sensing measurement session is completed in one transmission opportunity, the first time information may include: a first identifier bit configured to indicate a first exchange identity of a first measurement exchange; and a second identifier bit configured to indicate a first number of measurement exchange(s).

The first exchange identity of the first measurement exchange may be information that may uniquely identify the first measurement exchange, for example, an exchange serial number of the first measurement exchange.

As an example, the format of the first time information may be as follows:

| | |
|---|---|
| WLAN Sensing Instance ID | Number of Instance |

The WLAN Sensing Instance ID is the exchange identity of the first measurement exchange, and the Number of Instance is the first number of measurement exchange(s).

Specifically, the first number is configured to indicate to feed back measurement report(s) for the first number of measurement exchange(s) beginning with the first measurement exchange after NDP frame(s) corresponding to the first number of measurement exchange(s) beginning with the first measurement exchange is (are) received in the transmission opportunity.

If the first number is 1, the first time information is configured to indicate to feed back the measurement report for the first measurement exchange after an NDP frame corresponding to the first measurement exchange is received in the transmission opportunity.

If the first number is greater than 1, the first time information is configured to indicate that measurement reports for the first number of measurement exchanges (including the first measurement exchange) are fed back after NDP frames for the first number of measurement exchanges (including the first measurement exchange) are received in the transmission opportunity.

The measurement reports for the first number of measurement exchanges including the first measurement exchange may be fed back one by one by the responder of sensing in wireless local area network in the order in which the NDP frames are received, or the measurement reports for the first number of measurement exchanges including the first measurement exchange may be fed back in an aggregated manner.

As an example, if the first number is 5, the first time information is configured to indicate that after NDP frames corresponding to 5 measurement exchanges including the first measurement exchange and beginning with the first measurement exchange are received in the transmission opportunity, measurement report(s) for the 5 measurement exchanges including the first measurement exchange is (are) fed back.

Optionally, the first number may be configured to indicate to feed back a measurement report for the first measurement exchange after NDP frame(s) corresponding to the first number of measurement exchange(s) beginning with the first measurement exchange is (are) received in the transmission opportunity.

As an example, if the first number is 5, the first time information is configured to indicate that after NDP frames corresponding to 5 measurement exchanges including the first measurement exchange and beginning with the first measurement exchange are received in the transmission opportunity, a measurement report for the first measurement exchange is fed back.

Optionally, the first number may be configured to indicate that the NDP frame(s) corresponding to the first number of measurement exchange(s) is (are) received after the NDP frame corresponding to the first measurement exchange is received in the transmission opportunity, measurement reports for the first measurement exchange and the first number of measurement exchange(s) are fed back.

If the first number is 0, the first time information is configured to indicate that after the NDP frame corresponding to the first measurement exchange is received in the transmission opportunity, a measurement report for the first measurement exchange is fed back.

If the first number is greater than 0, the first time information is configured to indicate that if NDP frame(s) corresponding to the first number of measurement exchange(s) is (are) received after the NDP frame corresponding to the first measurement exchange is received in the transmission opportunity, measurement reports for the first measurement exchange and the first number of measurement exchange(s) after the first measurement exchange are fed back.

The measurement reports for the first measurement exchange and the first number of measurement exchange(s) after the first measurement exchange may be fed back one by one by the responder of sensing in wireless local area network in the order in which the NDP frames are received, or the measurement reports for the first measurement exchange and the first number of measurement exchange(s) may be fed back in an aggregated manner.

As an example, if the first number is 5, the first time information is configured to indicate that after NDP frames corresponding to 5 measurement exchanges are received after the NDP frame corresponding to the first measurement exchange is received in the transmission opportunity, measurement reports for the first measurement exchange and the 5 measurement exchanges after the first measurement exchange are fed back.

Optionally, the first number may be configured to indicate that after NDP frame(s) corresponding to the first number of measurement exchange(s) is (are) further received after the NDP frame corresponding to the first measurement exchange is received in the transmission opportunity, a measurement report for the first measurement exchange is fed back.

If the first number is 0, the first time information is configured to indicate that after the NDP frame corresponding to the first measurement exchange is received in the transmission opportunity, a measurement report for the first measurement exchange is fed back.

If the first number is greater than 0, the first time information is configured to indicate that after NDP frame(s) corresponding to the first number of measurement exchange(s) is (are) further received after the NDP frame corresponding to the first measurement exchange is received in the transmission opportunity, a measurement report for the first measurement exchange.

As an example, if the first number is 5, the first time information is configured to indicate that after the NDP frame corresponding to the first measurement exchange is received and further NDP frames corresponding to 5 measurement exchanges are received in the transmission opportunity, a measurement report for the first measurement exchange is fed back.

In an optional embodiment, when the wireless local area network sensing measurement session initiated by the initiator of sensing in wireless local area network corresponds to one transmission opportunity, that is, the measurement exchange(s) corresponding to the wireless local area network sensing measurement session is (are) completed in one transmission opportunity, the first time information may include: a first identifier bit configured to indicate a first exchange identity of a first measurement exchange, and a second identifier bit configured to indicate a second exchange identity of the second measurement exchange.

The first exchange identity and the second exchange identity may be information that can uniquely identify the first measurement exchange and the second measurement exchange, respectively, such as an exchange serial number of the first measurement exchange and an exchange serial number of the second measurement exchange.

As an example, the format of the first time information may be as follows:

| | |
|---|---|
| WLAN Sensing Instance ID1 | WLAN Sensing Instance ID2 |

The WLAN Sensing Instance ID1 is the first exchange identity of the first measurement exchange, and the WLAN Sensing Instance ID2 is the second exchange identity of the second measurement exchange.

Specifically, the second exchange identity is configured to indicate that after NDP frames corresponding to all measurement exchanges from the first measurement exchange to the second measurement exchange are received in the transmission opportunity, measurement reports for all measurement exchanges from the first measurement exchange to the second measurement exchange are fed back.

That is to say, the first exchange identity is the exchange serial number of the first measurement exchange, the second exchange identity is the exchange serial number of the second measurement exchange, and the first time information may be configured to indicate that after the NDP frames corresponding to all measurement exchanges in a serial number interval corresponding to the two exchange serial numbers are received, measurement reports for all measurement exchanges in the serial number interval corresponding to the two exchange serial numbers are fed back.

The measurement reports for all measurement exchanges from the first measurement exchange to the second measurement exchange may be fed back one by one by the responder of sensing in wireless local area network in the order in which the NDP frames are received, or the measurement reports for all measurement exchanges from the first measurement exchange to the second measurement exchange may be fed back in an aggregated manner.

As an example, the exchange serial number of the first measurement exchange is 1, and the exchange serial number of the second measurement exchange is 5. After the NDP frames corresponding to all measurement exchanges with exchange serial numbers 1 to 5 are received, measurement reports for all measurement exchanges with exchange serial numbers 1 to 5 are fed back.

Optionally, the second exchange identity may also be configured to indicate that if the NDP frame corresponding to the second measurement exchange is received after the NDP frame corresponding to the first measurement exchange is received in the transmission opportunity, a measurement report for the first measurement exchange is fed back.

It should be noted that the first measurement exchange and the second measurement exchange may be the same measurement exchange, that is, the first measurement exchange identity and the second measurement exchange identity may be the same exchange identity. For example, WLAN Sensing Instance ID1 and WLAN Sensing Instance ID2 in the above format of the first time information may indicate the same exchange identity.

In this case, the first time information may be configured to indicate the responder of sensing in wireless local area network to feed back the measurement report for the measurement exchange after receiving the NDP frame of the measurement exchange, or to feed back the measurement report for the measurement exchange after completing measurement of a next measurement exchange of the measurement exchange.

In an optional embodiment, the first time information further includes a third identifier bit configured to indicate a measurement phase of each measurement exchange.

By sending the measurement phase of the measurement exchange, the initiator of sensing in wireless local area network can enable the responder of sensing in wireless local area network to determine the reception time of the NDP frame corresponding to each measurement exchange based on the measurement phase of each measurement exchange, so as to further determine the feedback occasion of the measurement report for each measurement exchange.

As an example, in a case where the first time information includes a first identifier bit configured to indicate a first exchange identity of a first measurement exchange and a second identifier bit configured to indicate a first number of measurement exchange(s), the first time information may further include a third identifier bit configured to indicate a measurement phase of each measurement exchange.

For example, the format of the first time information may be as follows:

| | | |
|---|---|---|
| WLAN Sensing Instance ID | Number of Instance | Period |

The WLAN Sensing Instance ID is the first exchange identity of the first measurement exchange, the Number of Instance is the first number of measurement exchange(s), and the Period is the measurement phase of each measurement exchange.

As an example, in a case where the first time information includes a first identifier bit configured to indicate a first exchange identity of a first measurement exchange and a second identifier bit configured to indicate a second exchange identity of a second measurement exchange, the first time information may further include a third identifier bit configured to indicate the measurement phase of each measurement exchange.

For example, the format of the first time message may be as follows:

| | | |
|---|---|---|
| WLAN Sensing Instance ID1 | WLAN Sensing Instance ID2 | Period |

The WLAN Sensing Instance ID1 is the first exchange identity of the first measurement exchange, the WLAN Sensing Instance ID2 is the second exchange identity of the second measurement exchange, and the Period is the measurement phase of each measurement exchange.

In an optional embodiment, in a case where the wireless local area network sensing measurement session corresponds to one transmission opportunity, the initiator of sensing in wireless local area network sends a first trigger message after sending an NDP frame corresponding to a first target measurement exchange.

The first trigger message is configured to indicate to feed back a measurement report for the first target measurement exchange.

That is, after the initiator of sensing in wireless local area network sends the NDP corresponding to the first target measurement exchange, the initiator of sensing in wireless local area network may send a first trigger message to a responder of sensing in wireless local area network, so that the responder of sensing in wireless local area network may feed back the measurement report for the first target measurement exchange based on the feedback occasion of the measurement report for the first target measurement exchange indicated by the first time information.

If the first trigger message is configured to indicate one responder of sensing in wireless local area network (such as one STA device) to feed back a measurement report, the first trigger message may be a Poll message to indicate the corresponding responder of sensing in wireless local area network to feed back the measurement report for the first target measurement exchange. Optionally, the Poll message may include a device identity of the responder of sensing in wireless local area network and the exchange identity of a corresponding first target measurement exchange.

If the first trigger message is configured to indicate a plurality of responders in wireless local area network sensing (such as a plurality of STA devices) to feed back measurement reports, for example, the first trigger message may be a Beamforming Report Poll (BFRP) message. Optionally, the BFRP message includes a device identity of each responder of sensing in wireless local area network and an exchange identity of a first target measurement exchange corresponding to each responder of sensing in wireless local area network, so that each responder of sensing in wireless local area network feeds back a measurement report for the corresponding first target measurement exchange.

In a case where the first time information includes a first identifier bit configured to indicate a first exchange identity of a first measurement exchange and a second identifier bit configured to indicate a first number of measurement exchange(s), if the first number is configured to indicate that after NDP frame(s) corresponding to the first number of measurement exchange(s) beginning with the first measurement exchange is (are) received in the transmission opportunity, measurement report(s) for the first number of measurement exchange(s) beginning with the first measurement exchange is (are) fed back or the measurement report for the first measurement exchange is fed back, the first target measurement exchange is the first number of measurement exchange(s) beginning with the first measurement exchange.

If the first number is configured to indicate that after the NDP frame(s) corresponding to the first number of measurement exchange(s) is (are) received after the NDP frame corresponding to the first measurement exchange is received in the transmission opportunity, the measurement report for the first measurement exchange is fed back or the measurement reports for the first measurement exchange and the first number of measurement exchange(s) are fed back, the first target measurement exchange is the first measurement exchange and the first number of measurement exchange(s) after the first measurement exchange.

In a case where the first time information includes a first identifier bit configured to indicate a first exchange identity of a first measurement exchange and a second identifier bit configured to indicate a first exchange identity of a second measurement exchange, if the first time information is configured to indicate that after the NDP frames corresponding to all measurement exchanges from the first measurement exchange to the second measurement exchange are received, a measurement report for the first measurement exchange or measurements for all measurement exchanges from the first measurement exchange to the second measurement exchange are fed back, then the first target measurement exchange is the first measurement exchange or all measurement exchanges from the first measurement exchange to the second measurement exchange.

In an optional embodiment, in a case where the wireless local area network sensing measurement session initiated by the initiator of sensing in wireless local area network corresponds to a plurality of transmission opportunities, that is, the measurement exchange(s) corresponding to the wireless local area network sensing measurement session is (are) completed in a plurality of transmission opportunities, the first time information may include a fourth identifier bit configured to indicate a third exchange identity of a third measurement exchange and a fifth identifier bit configured to indicate a second number of Transmission Opportunity (TXOP).

The exchange identity of the third measurement exchange may be information that can uniquely identify the third measurement exchange, such as an exchange serial number of the third measurement exchange.

As an example, the format of the first time information may be as follows:

| | |
|---|---|
| WLAN Sensing Instance ID | Number of TXOP |

The WLAN Sensing Exchange ID is the third exchange identity of the third measurement exchange, and the Number of TXOP is the second number of transmission opportunity (opportunities).

Specifically, the second number is configured to indicate that a measurement report for the third measurement exchange is fed back after an interval of the second number of transmission opportunity (opportunities).

If the second number is 0, the first time information is configured to indicate that the measurement report for the third measurement exchange is fed back in the transmission opportunity where the NDP frame corresponding to the third measurement exchange is received.

If the second number is greater than 0, the first time information is configured to indicate that after the NDP frame corresponding to the third measurement exchange is received, the measurement report for the third measurement exchange is fed back after an interval of the second number of transmission opportunity (opportunities).

As an example, if the second number is 2, the first time information is configured to indicate that after the NDP frame corresponding to the third measurement exchange is received, the measurement report for the third measurement exchange is fed back in a transmission opportunity with an interval of 2 transmission opportunities from the transmission opportunity corresponding to the NDP frame corresponding to the third measurement exchange.

In an optional embodiment, in a case where the wireless local area network sensing measurement session initiated by the initiator of sensing in the wireless local area network corresponds to a plurality of transmission opportunities, the first time information may include a third exchange identity configured to indicate a third exchange identity of a third measurement exchange and a fifth identifier bit configured to indicate a first opportunity identity of a first transmission opportunity.

The first opportunity identity of the first transmission opportunity may be information that can uniquely identify the first transmission opportunity, such as an opportunity serial number of the first transmission opportunity.

As an example, the format of the first time information may be as follows:

| | |
|---|---|
| WLAN Sensing Instance ID | TXOP ID |

The WLAN Sensing Instance ID is the third exchange identity of the third measurement exchange, and the TXOP ID is the first opportunity identity of the first transmission opportunity.

Specifically, the first opportunity identity is configured to indicate that after the NDP frame corresponding to the third measurement exchange is received, a measurement report for the third measurement exchange is fed back in the first transmission opportunity or in a transmission opportunity after the first transmission opportunity.

In an optional embodiment, in a case where the wireless local area network sensing measurement session initiated by the initiator of sensing in wireless local area network corresponds to a plurality of transmission opportunities, the first time information may include a sixth identifier bit configured to indicate a wireless local area network sensing measurement setup identity and a seventh identifier bit configured to indicate a second opportunity identity of a second transmission opportunity.

The second opportunity identity of the second transmission opportunity may be information that can uniquely identify the second transmission opportunity, such as an opportunity serial number of the second transmission opportunity.

As an example, the format of the first time information may be as follows:

| | |
|---|---|
| WLAN Sensing Measurement Setup ID | TXOP ID |

The WLAN Sensing Measurement Setup ID is the wireless local area network sensing measurement setup identity, and the TXOP ID is the second opportunity identity of the second transmission opportunity.

Specifically, the second opportunity identity is configured to indicate that measurement reports for respective measurement exchanges corresponding to the wireless local area network sensing measurement setup identity are fed back in an aggregated manner after the second transmission opportunity. That is, the second opportunity identity is configured to indicate that after the NDP frames corresponding to all or part of the measurement exchanges corresponding to the wireless local area network sensing measurement setup identity are received in the second transmission opportunity or in a transmission opportunity before the second transmission opportunity, the measurement reports for above all or part of the measurement exchanges are fed back in an aggregated manner after the second transmission opportunity.

Optionally, the second opportunity identity is configured to indicate that measurement reports for respective measurement exchanges corresponding to the wireless local area network sensing measurement setup identity are fed back in an aggregated manner in the second transmission opportunity. That is, the second opportunity identity is configured to indicate that after NDP frames corresponding to all or part of the measurement exchanges corresponding to the wireless local area network sensing measurement setup identity are received in a transmission opportunity before the second transmission opportunity, the measurement reports for the measurement exchanges corresponding to the received NDP frames are fed back in an aggregated manner in the second transmission opportunity.

In an optional embodiment, in a case where the wireless local area network sensing measurement session initiated by the initiator of sensing in wireless local area network corresponds to a plurality of transmission opportunities, the first time information may include a sixth identifier bit configured to indicate a wireless local area network sensing measurement setup identity and a seventh identifier bit configured to indicate a third number of transmission opportunity (opportunities).

As an example, the format of the first time information may be as follows:

| | |
|---|---|
| WLAN Sensing Measurement Setup ID | Number of TXOP |

The WLAN Sensing Measurement Setup ID is the wireless local area network sensing measurement setup identity, and the Number of TXOP is the third number of transmission opportunity (opportunities).

Specifically, the third number is configured to indicate that measurement reports for respective measurement exchanges corresponding to the wireless local area network setup identity are fed back in an aggregated manner after an interval of the third number of transmission opportunity (opportunities).

That is, the initiator of sensing in wireless local area network sends NDP frames corresponding to part or all of the measurement exchanges corresponding to the wireless local area network setup identity in the first one of transmission opportunities, and the third number is configured to indicate that the measurement reports for all or part of the measurement exchanges corresponding to the first transmission opportunity are fed back in an aggregated manner after an interval of third number of transmission opportunity (opportunities) from the first one of transmission opportunities, or the third number is configured to indicate that measurement reports for respective measurement exchanges corresponding to the wireless local area network sensing measurement setup identity in a transmission opportunity with an interval of third number of transmission opportunity (opportunities) from the first one of transmission opportunities and respective previous transmission opportunities are fed back in an aggregated manner after an interval of third number transmission opportunity (opportunities) from the first one of transmission opportunities.

In an optional embodiment, in a case where the wireless local area network sensing measurement session initiated by the initiator of sensing in wireless local area network corresponds to a plurality of transmission opportunities, the first time information may include an eighth identifier bit configured to indicate a third opportunity identity of a third transmission opportunity and a ninth identifier bit configured to indicate a fourth opportunity identity of a fourth transmission opportunity.

The third opportunity identity and the fourth opportunity identity may be information for uniquely identifying the third transmission opportunity and the fourth transmission opportunity, respectively. For example, the third opportunity identity and the fourth opportunity identity may be corresponding opportunity serial numbers, respectively.

As an example, the format of the first time information may be as follows:

| | |
|---|---|
| TXOP ID1 | TXOP ID2 |

The TXOP ID1 is the third opportunity identity of the third transmission opportunity, and the TXOP ID2 is the fourth opportunity identity of the fourth transmission opportunity.

Specifically, the fourth opportunity identity is configured to indicate that measurement reports for all measurement exchanges corresponding to the third transmission opportunity to the fourth transmission opportunity are fed back in an aggregated manner after the fourth transmission opportunity.

As an example, the third opportunity identity is configured to represent the first one of transmission opportunities, and the fourth opportunity identity is configured to represent the third one of transmission opportunities. The first time information may be configured to indicate that measurement reports for all measurement exchanges corresponding to all NDP frames received between the first one of transmission opportunities and the third one of transmission opportunities are fed back in an aggregated manner after the third one of transmission opportunities.

The third transmission opportunity and the fourth transmission opportunity may be the same transmission opportunity, that is, the third opportunity identity and the fourth opportunity identity may be the same opportunity identity. For example, TXOP ID1 and TXOP ID2 in the format of the first time information may indicate the same opportunity identity.

In this case, the first time information may be configured to indicate a responder of sensing in wireless local area network to feed back, in one transmission opportunity, measurements and results of measurement exchanges corresponding to all NDP frames received in the transmission opportunity.

Optionally, the fourth opportunity identity may be configured to indicate to perform, in the fourth transmission opportunity, aggregated feedback for measurement report information for all measurement exchanges corresponding to the third transmission opportunity.

As an example, the third opportunity identity is configured to represent the first one of transmission opportunities, and the fourth opportunity identity is configured to represent the third one of transmission opportunities. The first time information may be configured to indicate that measurement reports for measurement exchanges corresponding to the NDP frames received in the first one of transmission opportunities are fed back in an aggregated manner in the third one of transmission opportunities.

In an optional embodiment, in a case where the wireless local area network sensing measurement session initiated by the initiator of sensing in wireless local area network corresponds to a plurality of transmission opportunities, the first time information may include an eighth identifier bit configured to indicate a third opportunity identity of a third transmission opportunity and a ninth identifier bit configured to indicate a fourth number of transmission opportunity (opportunities).

As an example, the format of the first time information may be as follows:

| | |
|---|---|
| TXOP ID | Number of TXOP |

The TXOP ID is the third opportunity identity of the third transmission opportunity, and the Number of TXOP is the fourth number of transmission opportunity (opportunities).

Specifically, the fourth number is configured to indicate that measurement reports for measurement exchanges corresponding to the fourth number of transmission opportunity (opportunities) beginning with the third transmission opportunity are fed back in an aggregated manner after an interval of the fourth number of transmission opportunity (opportunities) from the third transmission opportunity.

That is, the first time information is configured to indicate that measurement reports for measurement exchanges corresponding to NDP frames received in the fourth number of transmission opportunity (opportunities) beginning with the third transmission opportunity are fed back in an aggregated manner after an interval of the fourth number of transmission opportunity (opportunities) from the third transmission opportunity.

Optionally, the fourth number is configured to indicate to perform, in a transmission opportunity having an interval of fourth number of transmission opportunity (opportunities) from the third transmission opportunity, aggregated feedback for measurement reports for respective measurement exchanges corresponding to the third transmission opportunity.

That is, the first time information is configured to indicate that measurement reports for measurement exchanges corresponding to NDP frames received in the third transmission opportunity are fed back in an aggregated manner in a transmission opportunity having an interval of fourth number of transmission opportunity (opportunities) from the third transmission opportunity.

In an optional embodiment, the first time information further includes a tenth identifier bit configured to indicate a phase of a transmission opportunity.

By sending the measurement phase of the transmission opportunity, the initiator of sensing in wireless local area network can enable a responder of sensing in wireless local area network to further determine the feedback occasion of the measurement report for each measurement exchange based on the measurement phase of the transmission opportunity.

As an example, in a case where the first time information includes a fourth identifier bit configured to indicate a third exchange identity of a third measurement exchange and a fifth identifier bit configured to indicate a second number of transmission opportunity (opportunities), the first time information may further include a tenth identifier bit configured to indicate a phase of a transmission opportunity.

For example, the format of the first time information may be as follows:

| | | |
|---|---|---|
| WLAN Sensing Instance ID | Number of TXOP | Period |

The WLAN Sensing Instance ID is the third exchange identity of the third measurement exchange, the Number of TXOP is the second number of transmission opportunity (opportunities), and the Period is the phase of a transmission opportunity.

As an example, in a case where the first time information includes a fourth identifier bit configured to indicate a third exchange identity of a third measurement exchange and a fifth identifier bit configured to indicate a first opportunity identity of a first transmission opportunity, the first time information may further include a tenth identifier bit configured to indicate the phase of a transmission opportunity.

For example, the format of the first time message may be as follows:

| | | |
|---|---|---|
| WLAN Sensing Instance ID | TXOP ID | Period |

The WLAN Sensing Instance ID is the third exchange identity of the third measurement exchange, the TXOP ID is the first opportunity identity of the first transmission opportunity, and the Period is the phase of a transmission opportunity.

As an example, in a case where the first time information includes a sixth identifier bit configured to indicate a wireless local area network sensing measurement setup identity and a seventh identifier bit configured to indicate a second opportunity identity of a second transmission opportunity, the first time information may further include a tenth identifier bit configured to indicate the phase of a transmission opportunity.

For example, the format of the first time message may be as follows:

| | | |
|---|---|---|
| WLAN Sensing Measurement Setup ID | TXOP ID | Period |

The WLAN Sensing Measurement Setup ID is the wireless local area network sensing measurement setup identity, TXOP ID is the second opportunity identity of the second transmission opportunity, and Period is the phase of a transmission opportunity.

As an example, in a case where the first time information includes a sixth identifier bit configured to indicate a wireless local area network sensing measurement setup identity and a seventh identifier bit configured to indicate a third number of transmission opportunity (opportunities), the first time information may further include a tenth identifier bit configured to indicate the phase of a transmission opportunity.

For example, the format of the first time message may be as follows:

| | | |
|---|---|---|
| WLAN Sensing Measurement Setup | Number of | Period |
| ID | TXOP | |

The WLAN Sensing Measurement Setup ID is the wireless local area network sensing measurement setup identity, the Number of TXOP is the third number of transmission opportunity (opportunities), and the Period is the phase of a transmission opportunity.

As an example, in a case where the first time information includes an eighth identifier bit configured to indicate a third opportunity identity of a third transmission opportunity and a ninth identifier bit configured to indicate a fourth opportunity identity of a fourth transmission opportunity, the first time information may further include a tenth identifier bit configured to indicate a phase of a transmission opportunity.

For example, the format of the first time information may be as follows:

| | | |
|---|---|---|
| TXOP ID1 | TXOP ID2 | Period |

The TXOP ID1 is the third opportunity identity of the third transmission opportunity, the TXOP ID2 is the fourth opportunity identity of the fourth transmission opportunity, and the Period is the phase of a transmission opportunity.

As an example, in a case where the first time information includes an eighth identifier bit configured to indicate a third opportunity identity of a third transmission opportunity and a ninth identifier bit configured to indicate a fourth number of transmission opportunity (opportunities), the first time information may further include a tenth identifier bit configured to indicate a phase of a transmission opportunity.

For example, the format of the first time information may be as follows:

| | | |
|---|---|---|
| TXOP ID | Number of TXOP | Period |

The TXOP ID is the third opportunity identity of the third transmission opportunity, the Number of TXOP is the fourth number of transmission opportunity (opportunities), and the Period is the phase of a transmission opportunity.

In an optional embodiment, in a case where the wireless local area network sensing measurement session corresponds to a plurality of transmission opportunities, the initiator of sensing in wireless local area network sends a second trigger message after sending an NDP frame corresponding to a second target measurement exchange.

The second trigger message is configured to indicate to feed back a measurement report for the second target measurement exchange.

That is, after the initiator of sensing in wireless local area network sends an NDP corresponding to the second target measurement exchange, the initiator of sensing in wireless local area network sends the second trigger message to a responder of sensing in wireless local area network, so that the responder of sensing in wireless local area network feeds back a measurement report for the second target measurement exchange at a feedback occasion of the measurement report for the second target measurement exchange indicated by the first time information.

If the second trigger message is configured to indicate one responder of sensing in wireless local area network to feed back a measurement report, the first trigger message may be a poll message, so as to indicate a corresponding responder of sensing in wireless local area network to feed back a measurement report for the second target measurement exchange.

If the second trigger message is configured to indicate a plurality of responders in wireless local area network sensing to feed back measurement reports, the second trigger message may be a BFRP message. The BFRP message includes a device identity of each responder of sensing in wireless local area network and an exchange identity of a second target measurement exchange corresponding to each responder of sensing in wireless local area network, so that every responder in wireless local area network sensing feed back measurement reports for corresponding second target measurement exchanges.

In a case where the first time information includes a third identifier bit configured to indicate a third exchange identity of the third measurement exchange, the second target measurement exchange is the third measurement exchange.

In a case where the first time information includes a sixth identifier bit configured to indicate a wireless local area network sensing measurement setup identity and a seventh identifier bit configured to indicate a second opportunity identity of a second transmission opportunity, if the second opportunity identity is configured to indicate an aggregated feedback of measurement reports for respective measurement exchanges corresponding to the wireless local area network sensing measurement setup identity after the second transmission opportunity, the second target measurement exchange is all or part of the measurement exchanges corresponding to the wireless local area network sensing measurement setup identity in the second transmission opportunity and a transmission opportunity before the second transmission opportunity.

If the second opportunity identity is configured to indicate that the measurement reports for respective measurement exchanges corresponding to the wireless local area network sensing measurement setup identity are fed back in aggregated manner in the second transmission opportunity, then the second target measurement exchange is all or part of the measurement exchanges corresponding to the wireless local area network sensing measurement setup identity in a transmission opportunity before the second transmission opportunity.

In a case where the first time information includes a sixth identifier bit configured to indicate a wireless local area network sensing measurement setup identity and a seventh identifier bit configured to indicate a third number of transmission opportunity (opportunities), and the third number is configured to indicate that measurement reports for respective measurement exchanges corresponding to the wireless local area network setup identity are fed back in an aggregated manner after an interval of the third number of transmission opportunity (opportunities), the second target measurement exchange is part or all of measurement exchanges corresponding to the wireless local area network setup identity in a transmission opportunity with an interval of third number of transmission opportunity (opportunities) and a previous transmission opportunity.

In a case where the first time information includes an eighth identifier bit configured to indicate a third opportunity identity of a third transmission opportunity and a ninth identifier bit configured to indicate a fourth opportunity identity of a fourth transmission opportunity, if the fourth opportunity identity is configured to indicate that the measurement reports for all measurement exchanges corresponding to the third transmission opportunity to the fourth transmission opportunity are fed back in an aggregated manner after the fourth transmission opportunity, the second target measurement exchange is all measurement exchanges corresponding to the third transmission opportunity to the fourth transmission opportunity.

If the fourth opportunity identity is configured to indicate that measurement report information for all measurement exchanges corresponding to the third transmission opportunity are fed back in an aggregated manner in the fourth transmission opportunity, the second target measurement exchange is all measurement exchanges corresponding to the third transmission opportunity.

In a case where the first time information includes an eighth identifier bit configured to indicate a third opportunity identity of a third transmission opportunity and a ninth identifier bit configured to indicate a fourth number of transmission opportunity (opportunities), if the fourth number is configured to indicate that measurement reports for measurement exchanges corresponding to the fourth number of transmission opportunity (opportunities) beginning from the third transmission opportunity are fed back in aggregated manner after an interval of the fourth number of transmission an opportunity (opportunities) from the third transmission opportunity, the second target measurement exchange is measurement exchanges corresponding to the fourth number of transmission opportunity (opportunities) beginning from the third transmission opportunity.

If the fourth number is configured to indicate that measurement reports for respective measurement exchanges corresponding to the third transmission opportunity are fed back in an aggregated manner in a transmission opportunity with an interval of the fourth number of transmission opportunity (opportunities) from the third transmission opportunity, the second target measurement exchange is respective measurement exchanges corresponding to the third transmission opportunity.

In an optional embodiment, the initiator of sensing in wireless local area network may send a first message frame before sending the first time information.

The first message frame includes an eleventh identifier bit. The eleventh identifier bit is configured to indicate that the initiator of sensing in wireless local area network supports delayed feedback of a measurement report, that is, the eleventh identifier bit is configured to indicate that the initiator of sensing in wireless local area network supports delayed reception of a measurement report for a measurement exchange.

As an example, the initiator of sensing in wireless local area network may send the first message frame during the wireless local area network sensing measurement session setup procedure.

In an optional embodiment, the first message frame sent by the initiator of sensing in wireless local area network may include an information element of a wireless local area network sensing measurement parameter. The information element of the wireless local area network sensing measurement parameter includes the eleventh identifier bit to indicate that the initiator of sensing in wireless local area network supports delayed feedback of a measurement report.

The first message frame may be a wireless local area network sensing measurement session setup request message frame.

As shown in FIG. 2, an embodiment of the present disclosure provides a communication method. Optionally, the method may be applied to a responder of sensing in wireless local area network. The communication method shown in FIG. 2 may specifically include the following steps:

In step 201, first time information is received during a wireless local area network sensing measurement setup procedure. The first time information is configured to indicate a feedback occasion of a measurement report for at least one measurement exchange.

The first time information may be determined by an initiator of sensing in wireless local area network before a wireless local area network sensing measurement procedure. For example, the first time information may be determined by the initiator of sensing in wireless local area network during a wireless local area network sensing measurement setup procedure.

The first time information may be configured to indicate a delayed feedback occasion of a measurement report for at least one measurement exchange. For example, first time information may be configured to indicate a responder of sensing in wireless local area network to feed back a measurement report for at least one measurement exchange at any time after an NDP frame corresponding to the at least one measurement exchange is received.

In step 202, a measurement report for respective measurement exchange of the at least one measurement exchange is fed back based on the feedback occasion.

The first time information indicates a feedback occasion of a measurement report for at least one measurement exchange, and a responder of sensing in wireless local area network may feed back a corresponding measurement report based on the feedback occasion of the measurement report for each measurement exchange.

The first time information may indicate a feedback occasion of measurement reports for a plurality of measurement exchanges, and a responder of sensing in wireless local area network may perform aggregated feedback for the measurement reports for the plurality of measurement exchanges in the corresponding feedback occasion. That is, aggregated feedback information is sent, and the aggregated feedback information includes an exchange identity of each measurement exchange and its corresponding measurement report.

The measurement report for each measurement exchange may be CSI or CQI, which is not limited here.

The first time information may indicate a feedback occasion of a measurement report for one measurement exchange. The first time information includes an exchange identity of a certain measurement exchange. A responder of sensing in wireless local area network may send a measurement report for the measurement exchange after completing the measurement of a measurement exchange after the measurement exchange, so that the initiator of sensing in wireless local area network can receive the measurement report for the measurement exchange after completing the measurement of the next measurement exchange of the measurement exchange.

In an optional embodiment, in a case where a wireless local area network sensing measurement session initiated by the initiator of sensing in wireless local area network corresponds to one transmission opportunity, the first time information may include a first identifier bit configured to indicate a first exchange identity of a first measurement exchange and a second identifier bit configured to indicate a first number of measurement exchange(s).

The first exchange identity of the first measurement exchange may be information that can uniquely identify the first measurement exchange, such as an exchange serial number of the first measurement exchange.

As an example, the format of the first time information may be as follows:

| | |
|---|---|
| WLAN Sensing Instance ID | Number of Instance |

The WLAN Sensing Instance ID is the exchange identity of the first measurement exchange, and the Number of Instance is the first number of measurement exchange(s).

Specifically, the first number is configured to indicate that measurement reports for the first number of measurement exchange(s) beginning with the first measurement exchange are fed back after NDP frames corresponding to the first number of measurement exchange(s) beginning with the first measurement exchange are received in the transmission opportunity. The responder of sensing in wireless local area network may feed back the measurement reports for the first number of measurement exchange(s) beginning with the first measurement exchange after NDP frame(s) corresponding to the first number of measurement exchange(s) beginning with the first measurement exchange is (are) received in the transmission opportunity.

The responder of sensing in wireless local area network feeds back the measurement report(s) for the first number of measurement exchange(s) beginning with the first measurement exchange one by one in the order in which the NDP frame(s) is (are) received, or may alternatively feed back the measurement report(s) for the first number of measurement exchange(s) beginning with the first measurement exchange in an aggregated manner.

Optionally, the first number may be configured to indicate that a measurement report for the first measurement exchange is fed back after NDP frame(s) corresponding to the first number of measurement exchange(s) beginning with the first measurement exchange is (are) received in the transmission opportunity. The responder of sensing in wireless local area network may feed back the measurement report for the first measurement exchange after NDP frame(s) corresponding to the first number of measurement exchange(s) beginning with the first measurement exchange is (are) received in the transmission opportunity.

Optionally, the first number may be configured to indicate that the measurement report for the first measurement exchange is fed back after NDP frame(s) corresponding to the first number of measurement exchange(s) is (are) received after the NDP frame corresponding to the first measurement exchange is received in the transmission opportunity. The responder of sensing in wireless local area network feeds back the measurement report for the first measurement exchange after NDP frame(s) corresponding to the first number of measurement exchange(s) is (are) received after the NDP frame corresponding to the first measurement exchange is received in the transmission opportunity.

In an optional embodiment, in a case where the wireless local area network sensing measurement session initiated by the initiator of sensing in wireless local area network corresponds to one transmission opportunity, the first time information may include a first identifier bit configured to indicate a first exchange identity of a first measurement exchange and a second identifier bit configured to indicate a second exchange identity of a second measurement exchange.

The first exchange identity and the second exchange identity may be information that can uniquely identify the first measurement exchange and the second measurement exchange respectively, such as an exchange serial number of the first measurement exchange and an exchange serial number of the second measurement exchange respectively.

As an example, the format of the first time information may be as follows:

| | |
|---|---|
| WLAN Sensing Instance ID1 | WLAN Sensing Instance ID2 |

The WLAN Sensing Instance ID1 is the first exchange identity of the first measurement exchange, and the WLAN Sensing Instance ID2 is the second exchange identity of the second measurement exchange.

Specifically, the second exchange identity is configured to indicate that measurement reports for all measurements from the first measurement exchange to the second measurement exchange are fed back after NDP frames corresponding to all measurement exchanges from the first measurement exchange to the second measurement exchange are received in the transmission opportunity. The responder of sensing in wireless local area network feeds back measurement reports for all measurement exchanges from the first measurement exchange to the second measurement exchange after NDP frames corresponding to all measurement exchanges from the first measurement exchange to the second measurement exchange are received.

The responder of sensing in wireless local area network feeds back the measurement reports for all measurement exchanges from the first measurement exchange to the second measurement exchange one by one in the order in which the NDP frames are received, or may alternatively feed back the measurement reports for all measurement exchanges from the first measurement exchange to the second measurement exchange in an aggregated manner.

Optionally, the second exchange identity may also be configured to indicate that the measurement report for the first measurement exchange is fed back if the NDP frame corresponding to the second measurement exchange is received after the NDP frame corresponding to the first measurement exchange is received in the transmission opportunity. That is, the responder of sensing in wireless local area network feeds back the measurement report for the first measurement exchange if the NDP frame corresponding to the second measurement exchange is received after the NDP frame corresponding to the first measurement exchange is received in the transmission opportunity.

It should be noted that the first measurement exchange and the second measurement exchange may be the same measurement exchange, that is, the first measurement exchange identity and the second measurement exchange identity may be the same exchange identity. For example, WLAN Sensing Instance ID1 and WLAN Sensing Instance ID2 in the above format of the first time information may indicate the same exchange identity.

In this case, the responder of sensing in wireless local area network may feed back a measurement report for the measurement exchange after receiving the NDP frame corresponding to the measurement exchange, or the responder of sensing in wireless local area network may feed back a measurement report for the measurement exchange after completing measurement of a next measurement exchange of the measurement exchange.

In an optional embodiment, the first time information further includes a third identifier bit configured to indicate a measurement phase of each measurement exchange.

The responder of sensing in wireless local area network may determine the reception time of the NDP frame corresponding to each measurement exchange based on the measurement phase of the measurement exchange, and may feed back a corresponding measurement report based on a feedback occasion of the measurement report for each measurement exchange.

As an example, in a case where the first time information includes a first identifier bit configured to indicate a first exchange identity of a first measurement exchange and a second identifier bit configured to indicate a first number of measurement exchanges, the first time information may further include a third identifier bit configured to indicate a measurement phase of each measurement exchange.

For example, the format of the first time information may be as follows:

| | | |
|---|---|---|
| WLAN Sensing Instance ID | Number of Instance | Period |

The WLAN Sensing Instance ID is the first exchange identity of the first measurement exchange, the Number of Instance is the first number of measurement exchange(s), and the Period is the measurement phase of each measurement exchange.

As an example, in a case where the first time information includes a first identifier bit configured to indicate a first exchange identity of a first measurement exchange and a second identifier bit configured to indicate a second exchange identity of a second measurement exchange, the first time information may further include a third identifier bit configured to indicate the measurement phase of each measurement exchange.

For example, the format of the first time message may be as follows:

| | | |
|---|---|---|
| WLAN Sensing Instance ID1 | WLAN Sensing Instance ID2 | Period |

The WLAN Sensing Instance ID1 is the first exchange identity of the first measurement exchange, the WLAN Sensing Instance ID2 is the second exchange identity of the second measurement exchange, and the Period is the measurement phase of each measurement exchange.

In an optional embodiment, in a case where the wireless local area network sensing measurement session corresponds to one transmission opportunity, the initiator of sensing in wireless local area network sends a first trigger message after sending an NDP frame corresponding to a first target measurement exchange.

For a responder of sensing in wireless local area network, after the responder of sensing in the wireless local area network receives the NDP frame corresponding to the first target measurement exchange, if the first trigger information is received, the responder of sensing in wireless local area network feeds back a measurement report for the first target measurement exchange based on a feedback occasion of the measurement report for the first target measurement exchange.

In an optional embodiment, in a case where the wireless local area network sensing measurement session initiated by the initiator of sensing in wireless local area network corresponds to a plurality of transmission opportunities, the first time information may include a fourth identifier bit configured to indicate a third exchange identity of a third measurement exchange and a fifth identifier bit configured to indicate a second number of transmission opportunity (opportunities).

The exchange identity of the third measurement exchange may be information that can uniquely identify the third measurement exchange, for example, it may be an exchange serial number of the third measurement exchange.

As an example, the format of the first time information may be as follows:

| | |
|---|---|
| WLAN Sensing Instance ID | Number of TXOP |

The WLAN Sensing Instance ID is the third exchange identity of the third measurement exchange, and the Number of TXOP is the second number of transmission opportunity (opportunities).

Specifically, the second number is configured to indicate that the measurement report for the third measurement exchange is fed back after an interval of a second number of transmission opportunity (opportunities). After receiving the NDP frame corresponding to the third measurement exchange, the responder of sensing in wireless local area network feeds back the measurement report for the third measurement exchange after an interval of the second number of transmission opportunity (opportunities).

In an optional embodiment, in a case where the wireless local area network sensing measurement session initiated by the initiator of sensing in wireless local area network corresponds to a plurality of transmission opportunities, the first time information may include a fourth identifier bit configured to indicate a third exchange identity of a third measurement exchange and a fifth identifier bit configured to indicate a first opportunity identity of a first transmission opportunity.

The first opportunity identity of the first transmission opportunity may be information that can uniquely identify the first transmission opportunity, such as an opportunity serial number of the first transmission opportunity.

As an example, the format of the first time information may be as follows:

| | |
|---|---|
| WLAN Sensing Instance ID | TXOP ID |

The WLAN Sensing Instance ID is the third exchange identity of the third measurement exchange, and the TXOP ID is the first opportunity identity of the first transmission opportunity.

Specifically, the first opportunity identity is configured to indicate that after the NDP frame corresponding to the third measurement exchange is received, the measurement report for the third measurement exchange is fed back in the first transmission opportunity or in a transmission opportunity after the first transmission opportunity. After receiving the NDP frame corresponding to the third measurement exchange, the responder of sensing in wireless local area network feeds back the measurement report for the third measurement exchange in the first transmission opportunity or after the first transmission opportunity.

In an optional embodiment, in a case where the wireless local area network sensing measurement session initiated by the initiator of sensing in wireless local area network corresponds to a plurality of transmission opportunities, the first time information may include a sixth identifier bit configured to indicate a wireless local area network sensing measurement setup identity and a seventh identifier bit configured to indicate a second opportunity identity of a second transmission opportunity.

The second opportunity identity of the second transmission opportunity may be information that can uniquely identify the second transmission opportunity, such as an opportunity serial number of the second transmission opportunity.

As an example, the format of the first time information may be as follows:

| | |
|---|---|
| WLAN Sensing Measurement Setup ID | TXOP ID |

The WLAN Sensing Measurement Setup ID is the wireless local area network sensing measurement setup identity, and the TXOP ID is the second opportunity identity of the second transmission opportunity.

Specifically, the second opportunity identity is configured to indicate that measurement reports for respective measurement exchanges corresponding to the wireless local area network sensing measurement setup identity are fed back in an aggregated manner after the second transmission opportunity. After the responder of sensing in wireless local area network receives the NDP frames corresponding to all or part of the measurement exchanges corresponding to the wireless local area network sensing measurement setup identity in the second transmission opportunity and a transmission opportunity before the second transmission opportunity, the responder feeds back the measurement reports for above all or part of measurement exchanges in an aggregated manner after the second transmission opportunity.

Optionally, the second opportunity identity is configured to indicate that the measurement reports for respective measurement exchanges corresponding to the wireless local area network sensing measurement setup identity are fed back in an aggregated manner in the second transmission opportunity. After the responder of sensing in wireless local area network receives NDP frames corresponding to all or part of the measurement exchanges corresponding to the wireless local area network sensing measurement setup identity in a transmission opportunity before the second transmission opportunity, the responder feeds back the measurement reports for the measurement exchanges corresponding to the received NDP frames in the second transmission opportunity.

In an optional embodiment, in a case where the wireless local area network sensing measurement session initiated by the initiator of sensing in wireless local area network corresponds to a plurality of transmission opportunities, the first time information may include a sixth identity configured to indicate a wireless local area network sensing measurement setup identifier bit and a seventh identifier bit configured to indicate a third number of transmission opportunity (opportunities).

As an example, the format of the first time information may be as follows:

| | |
|---|---|
| WLAN Sensing Measurement Setup ID | Number of TXOP |

The WLAN Sensing Measurement Setup ID is the wireless local area network sensing measurement setup identity, and the Number of TXOP is the third number of transmission opportunity (opportunities).

Specifically, the third number is configured to indicate that the measurement reports for respective measurement exchanges corresponding to the wireless local area network setup identity are fed back in an aggregated manner after an interval of the third number of transmission opportunity (opportunities). If the initiator of sensing in wireless local area network sends NDP frames corresponding to part or all of the measurement exchanges corresponding to the wireless local area network setup identity in the first one of transmission opportunities, the responder of sensing in wireless local area network may feed back measurement reports for above all or part of the measurement exchanges corresponding to the first one of transmission opportunities after an interval of the third number of transmission opportunity (opportunities) from the first one of transmission opportunities, or the responder of sensing in wireless local area network may feed back, after an interval of the third number of transmission opportunity (opportunities) from the first one of transmission opportunities, measurement reports for respective measurement exchanges corresponding to the wireless local area network sensing measurement setup identity in a transmission opportunity with an interval of the third number of transmission opportunity (opportunities) from the first one of transmission opportunities and in respective previous transmission opportunity (opportunities).

In an optional embodiment, in a case where the wireless local area network sensing measurement session initiated by the initiator of sensing in wireless local area network corresponds to a plurality of transmission opportunities, the first time information may include an eighth identifier bit configured to indicate a third opportunity identity of a third transmission opportunity and a ninth identifier bit configured to indicate a fourth opportunity identity of a fourth transmission opportunity.

The third opportunity identity and the fourth opportunity identity may respectively be information that uniquely identifies the third transmission opportunity and the fourth transmission opportunity. For example, the third opportunity identity and the fourth opportunity identity may be corresponding opportunity serial numbers respectively.

As an example, the format of the first time information may be as follows:

| | |
|---|---|
| TXOP ID1 | TXOP ID2 |

TXOP ID1 is the third opportunity identity of the third transmission opportunity, and TXOP ID2 is the fourth opportunity identity of the fourth transmission opportunity.

Specifically, the fourth opportunity identity is configured to indicate that measurement reports for all measurement exchanges corresponding to the third transmission opportunity to the fourth transmission opportunity are fed back in an aggregated manner after the fourth transmission opportunity. The responder of sensing in wireless local area network may feed back measurement reports for all measurement exchanges corresponding to NDP frames received in the third transmission opportunity to the fourth transmission opportunity in an aggregated manner after the fourth transmission opportunity.

The third transmission opportunity and the fourth transmission opportunity may be the same transmission opportunity. That is, the third opportunity identity and the fourth opportunity identity may be the same opportunity identity. For example, TXOP ID1 and TXOP ID2 in the format of the first time information may indicate the same opportunity identity.

In this case, the responder of sensing in wireless local area network may feed back, in one transmission opportunity, measurements and results of the measurement exchanges corresponding to all NDP frames received in the transmission opportunity.

Optionally, the fourth opportunity identity may be configured to indicate that measurement report information for all measurement exchanges corresponding to the third transmission opportunity is fed back in an aggregated manner in the fourth transmission opportunity. The responder of sensing in wireless local area network may feed back the measurement reports for the measurement exchanges corresponding to the NDP frames received in the third transmission opportunity in an aggregated manner in the fourth transmission opportunity.

In an optional embodiment, in a case where the wireless local area network sensing measurement session initiated by the initiator of sensing in wireless local area network corresponds to a plurality of transmission opportunities, the first time information may include an eighth identifier bit configured to indicate a third opportunity identity of a third transmission opportunity and a ninth identifier bit configured to indicate a fourth number of transmission opportunity (opportunities).

As an example, the format of the first time information may be as follows:

| | |
|---|---|
| TXOP ID | Number of TXOP |

TXOP ID is the third opportunity identity of the third transmission opportunity, and Number of TXOP is the fourth number of transmission opportunity (opportunities).

Specifically, the fourth number is configured to indicate that measurement reports for measurement exchanges corresponding to the fourth number of transmission opportunity (opportunities) beginning with the third transmission opportunity are fed back in an aggregated manner after an interval of the fourth number of transmission opportunity (opportunities) from the third transmission opportunity. The responder of sensing in wireless local area network may, after an interval of the fourth number of transmission opportunity (opportunities) from the third transmission opportunity, feed back measurement reports for measurement exchanges corresponding to NDP frames received in the fourth number of transmission opportunity (opportunities) beginning with the third transmission opportunity in an aggregated manner.

Optionally, the fourth number is configured to indicate that measurement reports for respective measurement exchanges corresponding to the third transmission opportunity are fed back in an aggregated manner in a transmission opportunity with an interval of the fourth number of transmission opportunity (opportunities) from the third transmission opportunity. The responder of sensing in wireless local area network may feed back measurement reports for measurement exchanges corresponding to the NDP frames received in the third transmission opportunity in an aggregated manner in a transmission opportunity with an interval of the fourth number of transmission opportunity (opportunities) from the third transmission opportunity.

In an optional embodiment, the first time information further includes a tenth identifier bit configured to indicate a phase of a transmission opportunity.

The initiator of sensing in wireless local area network determines the measurement phase of the transmission opportunity through the tenth identifier bit, and can further determine the feedback occasion of the measurement report for each measurement exchange.

As an example, in a case where the first time information includes a fourth identifier bit configured to indicate a third exchange identity of a third measurement exchange and a fifth identifier bit configured to indicate a second number of transmission opportunity (opportunities), the first time information may further include a tenth identifier bit configured to indicate the phase of a transmission opportunity.

For example, the format of the first time message may be as follows:

| | | |
|---|---|---|
| WLAN Sensing Instance ID | Number of TXOP | Period |

WLAN Sensing Instance ID is the third exchange identity of the third measurement exchange, Number of TXOP is the second number of transmission opportunity (opportunities), and Period is the phase of a transmission opportunity.

As an example, in a case where the first time information includes a fourth identifier bit configured to indicate a third exchange identity of a third measurement exchange and a fifth identifier bit configured to indicate a first opportunity identity of a first transmission opportunity, the first time information may further include a tenth identifier bit configured to indicate a phase of a transmission opportunity.

For example, the format of the first time information may be as follows:

| | | |
|---|---|---|
| WLAN Sensing Instance ID | TXOP ID | Period |

The WLAN Sensing Instance ID is the third exchange identity of the third measurement exchange, the TXOP ID is the first opportunity identity of the first transmission opportunity, and the Period is the phase of a transmission opportunity.

As an example, in a case where the first time information includes a sixth identifier bit configured to indicate a wireless local area network sensing measurement setup identity and a seventh identifier bit configured to indicate a second opportunity identity of a second transmission opportunity, the first time information may further include a tenth identifier bit configured to indicate a phase of a transmission opportunity.

For example, the format of the first time message may be as follows:

| | | |
|---|---|---|
| WLAN Sensing Measurement Setup ID | TXOP ID | Period |

The WLAN Sensing Measurement Setup ID is the wireless local area network sensing measurement setup identity, the TXOP ID is the second opportunity identity of the second transmission opportunity, and the Period is the phase of a transmission opportunity.

As an example, in a case where the first time information includes a sixth identifier bit configured to indicate a wireless local area network sensing measurement setup identity and a seventh identifier bit configured to indicate a third number of transmission opportunity (opportunities), the first time information may also include a tenth identifier bit configured to indicate a phase of a transmission opportunity.

For example, the format of the first time information may be as follows:

| | | |
|---|---|---|
| WLAN Sensing Measurement Setup ID | Number of TXOP | Period |

The WLAN Sensing Measurement Setup ID is the wireless local area network sensing measurement setup identity, the Number of TXOP is the third number of transmission opportunity (opportunities), and the Period is the phase of a transmission opportunity.

As an example, in a case where the first time information includes an eighth identifier bit configured to indicate a third opportunity identity of a third transmission opportunity and a ninth identifier bit configured to indicate a fourth opportunity identity of a fourth transmission opportunity, the first time information may further include a tenth identifier bit configured to indicate a phase of a transmission opportunity.

For example, the format of the first time information may be as follows:

| | | |
|---|---|---|
| TXOP ID1 | TXOP ID2 | Period |

The TXOP ID1 is the third opportunity identity of the third transmission opportunity, the TXOP ID2 is the fourth opportunity identity of the fourth transmission opportunity, and the Period is the phase of a transmission opportunity.

As an example, in a case where the first time information includes an eighth identifier bit configured to indicate a third opportunity identity of a third transmission opportunity and a ninth identifier bit configured to indicate a fourth number of transmission opportunity (opportunities), the first time information may further include a tenth identifier bit configured to indicate a phase of a transmission opportunity.

For example, the format of the first time information may be as follows:

| | | |
|---|---|---|
| TXOP ID | Number of TXOP | Period |

The TXOP ID is the third opportunity identity of the third transmission opportunity, the Number of TXOP is the fourth number of transmission opportunity (opportunities), and the Period is the phase of a transmission opportunity.

In an optional embodiment, in a case where the wireless local area network sensing measurement session corresponds to a plurality of transmission opportunities, the initiator of sensing in wireless local area network sends a second trigger message after sending an NDP frame corresponding to a second target measurement exchange.

For a responder of sensing in wireless local area network, after the responder of sensing in wireless local area network receives the NDP frame corresponding to the second target measurement exchange, if the second trigger information is received, the responder feeds back the measurement report for the second target measurement exchange based on the feedback occasion of the measurement report for the second target measurement exchange.

In an optional embodiment, the responder of sensing in wireless local area network may send a second message frame before performing wireless local area network sensing measurement.

The second message frame includes a twelfth identifier bit, and the twelfth identifier bit is configured to indicate that the responder of sensing in wireless local area network supports delayed feedback of a measurement report.

As an example, the responder of sensing in wireless local area network may send the second message frame during the wireless local area network sensing measurement session setup procedure.

In an optional embodiment, the second message frame sent by the responder of sensing in wireless local area network may include an information element of a wireless local area network sensing measurement parameter. The information element of the wireless local area network sensing measurement parameter includes the twelfth identifier bit to indicate that the responder of sensing in wireless local area network supports delayed feedback of a measurement report.

The second message frame may be a measurement session setup response message frame in wireless local area network sensing.

Based on the communication method provided in the embodiments of the present disclosure, the initiator of sensing in wireless local area network can indicate the feedback occasion of the measurement report for at least one measurement exchange during the wireless local area network sensing measurement setup procedure, so that the responder of sensing in wireless local area network can feed back the measurement report for the corresponding measurement exchange at the corresponding feedback occasion.

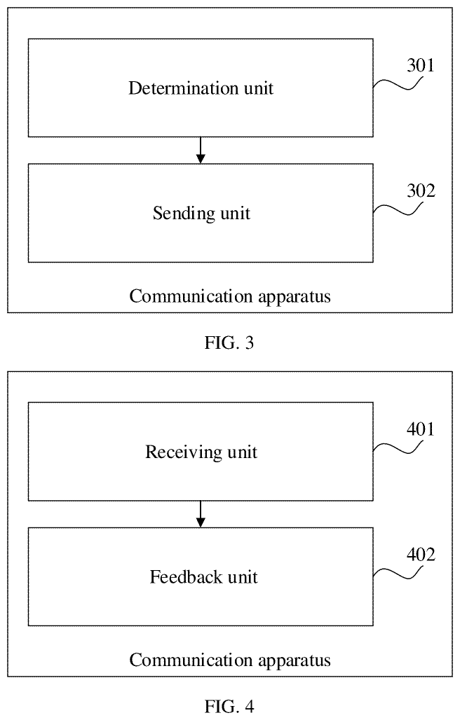

As shown in FIG. 3, an embodiment of the present disclosure provides a communication apparatus. The apparatus includes a determination unit 301 and a sending unit 302.

The determination unit 301 is configured to determine first time information, wherein the first time information is configured to indicate a feedback occasion of a measurement report for at least one measurement exchange.

The sending unit 302 is configured to send the first time information during a wireless local area network sensing measurement setup procedure.

Optionally, in an embodiment of the present disclosure, in a case where a wireless local area network sensing measurement session corresponds to a transmission opportunity, the first time information includes a first identifier bit and a second identifier bit:

wherein the first identifier bit is configured to indicate a first exchange identity of a first measurement exchange:

wherein the second identifier bit is configured to indicate a first number of at least one measurement exchange or a second exchange identity of a second measurement exchange, wherein: the first number is configured to indicate to feed back a measurement report for the first number of at least one measurement exchange beginning with the first measurement exchange, after a Null Data Packet (NDP) frame corresponding to the first number of at least one measurement exchange beginning with the first measurement exchange is received in the transmission opportunity: the second exchange identity is configured to indicate to feed back measurement reports for measurement exchanges from the first measurement exchange to the second measurement exchange after NDP frames corresponding to the measurement exchanges from the first measurement exchange to the second measurement exchange are received in the transmission opportunity.

Optionally, in an embodiment of the present disclosure, the first time information further includes a third identifier bit, and the third identifier bit is configured to indicate a measurement phase of each measurement exchange.

Optionally, in an embodiment of the present disclosure, in a case where a wireless local area network sensing measurement session corresponds to a plurality of transmission opportunities, the first time information includes at least one of the following:
a fourth identifier bit and a fifth identifier bit, wherein: the fourth identifier bit is configured to indicate a third exchange identity of a third measurement exchange: the fifth identifier bit is configured to indicate a second number of at least one transmission opportunity or a first opportunity identity of a first transmission opportunity, wherein the second number is configured to indicate to feed back a measurement report for the third measurement exchange after an interval of the second number of at least one transmission opportunity, and the first opportunity identity is configured to indicate to feedback back the measurement report for the third measurement exchange after the first transmission opportunity;
a sixth identifier bit and a seventh identifier bit, wherein: the sixth identifier bit is configured to indicate a wireless local area network sensing measurement setup identity: the seventh identifier bit is configured to indicate a third number of at least one transmission opportunity or a second opportunity identity of a second transmission opportunity, wherein the third number is configured to indicate to perform an aggregated feedback for measurement reports for respective transmission exchanges corresponding to the wireless local area network sensing measurement setup identity after an interval of the third number of at least one transmission opportunity, and the second opportunity identify is configured to indicate to perform an aggregated feedback for measurement reports for respective transmission exchanges corresponding to the wireless local area network sensing measurement setup identity after the second transmission opportunity;
an eighth identifier bit and a ninth identifier bit, wherein: the eighth identifier bit is configured to indicate a third opportunity identity of a third transmission opportunity: the ninth identifier bit is configured to indicate a fourth number of at least one transmission opportunity or a fourth opportunity identity of a fourth transmission opportunity, wherein the fourth number is configured to indicate to perform an aggregated feedback for measurement reports for measurement exchanges corresponding to the fourth number of at least one transmission opportunity beginning with the third transmission opportunity after an interval of the fourth number of at least one transmission opportunity from the third transmission opportunity, and the fourth opportunity identity is configured to indicate to perform an aggregated feedback for measurement reports for measurement exchanges from the third transmission opportunity to the fourth transmission opportunity after the fourth transmission opportunity.

Optionally, in an embodiment of the present disclosure, the first time information further includes a tenth identifier bit, and the tenth identifier bit is configured to indicate a phase of the transmission opportunity.

Optionally, in an embodiment of the present disclosure, the sending unit 302 is further configured to:
send a first message frame during a wireless local area network sensing measurement session setup procedure, wherein the first message frame includes an eleventh identifier bit, and the eleventh identifier bit is configured to indicate that the initiator of sensing in wireless local area network supports a delayed feedback for the measurement report.

Optionally, in an embodiment of the present disclosure, the first message frame includes an information element of a wireless local area network sensing measurement parameter, and the information element of the wireless local area network sensing measurement parameter includes the eleventh identifier bit.

Optionally, in an embodiment of the present disclosure, the sending unit 302 is further configured to:
after sending an NDP frame corresponding to a first target measurement exchange, send a first trigger message, wherein the first trigger message is configured to indicate to feed back a measurement report for the first target measurement exchange;
wherein the first target measurement exchange is the first number of at least one measurement exchange beginning with the first measurement exchange, or all measurement exchanges from the first measurement exchange to the second measurement exchange.

Optionally, in an embodiment of the present disclosure, the sending unit 302 is further configured to:
after sending an NDP frame corresponding to a second target measurement exchange, send a second trigger message, wherein the second trigger message is configured to indicate to feed back a measurement report for the second target measurement exchange;
in a case where the first time information includes the fourth identifier bit and the fifth identifier bit, the second target measurement exchange is the third measurement exchange;
in a case where the first time information includes the sixth identifier bit and the seventh identifier bit, the second target measurement exchange is respective transmission exchanges corresponding to the wireless local area network sensing measurement setup identity in the third number of at least one transmission opportunity, or respective transmission exchanges corresponding to the wireless local area network sensing measurement setup identity before the second transmission opportunity including the second transmission opportunity;
in a case where the first time information includes the ninth identifier bit and the tenth identifier bit, the second target measurement exchange is measurement exchanges corresponding to the fourth number of at least one transmission opportunity beginning with the third transmission opportunity, or measurement exchanges corresponding to the third transmission opportunity to the fourth transmission opportunity.

As shown in FIG. 4, an embodiment of the present disclosure provides a communication apparatus. The apparatus includes a receiving unit 401 and a feedback unit 402.

The receiving unit 401 is configured to receive first time information during a wireless local area network sensing measurement setup procedure, wherein the first time information is configured to indicate a feedback occasion of a measurement report for at least one measurement exchange.

The feedback unit 402 is configured to, based on the feedback occasion, feeding back the measurement report for respective measurement exchange.

Optionally, in an embodiment of the present disclosure, in a case where a wireless local area network sensing measurement session corresponds to a transmission opportunity, the first time information includes a first identifier bit and a second identifier bit:
wherein the first identifier bit is configured to indicate a first exchange identity of a first measurement exchange;
wherein the second identifier bit is configured to indicate a first number of at least one measurement exchange or a second exchange identity of a second measurement exchange, wherein: the first number is configured to indicate to feed back a measurement report for the first number of at least one measurement exchange beginning with the first measurement exchange, after a Null Data Packet (NDP) frame corresponding to the first number of at least one measurement exchange beginning with the first measurement exchange is received in the transmission opportunity: the second exchange identity is configured to indicate to feed back measurement reports for measurement exchanges from the first measurement exchange to the second measurement exchange after NDP frames corresponding to the measurement exchanges from the first measurement exchange to the second measurement exchange are received in the transmission opportunity.

Optionally, in an embodiment of the present disclosure, the first time information further includes a third identifier bit, and the third identifier bit is configured to indicate a measurement phase of each measurement exchange.

Optionally, in an embodiment of the present disclosure, in a case where a wireless local area network sensing measurement session corresponds to a plurality of transmission opportunities, the first time information includes at least one of the following:
a fourth identifier bit and a fifth identifier bit, wherein: the fourth identifier bit is configured to indicate a third exchange identity of a third measurement exchange: the fifth identifier bit is configured to indicate a second number of at least one transmission opportunity or a first opportunity identity of a first transmission opportunity, wherein the second number is configured to indicate to feed back a measurement report for the third measurement exchange after an interval of the second number of at least one transmission opportunity, and the first opportunity identity is configured to indicate to feedback back the measurement report for the third measurement exchange after the first transmission opportunity;
a sixth identifier bit and a seventh identifier bit, wherein: the sixth identifier bit is configured to indicate a wireless local area network sensing measurement setup identity: the seventh identifier bit is configured to indicate a third number of at least one transmission opportunity or a second opportunity identity of a second transmission opportunity, wherein the third number is configured to indicate to perform an aggregated feedback for measurement reports for respective transmission exchanges corresponding to the wireless local area network sensing measurement setup identity after an interval of the third number of at least one transmission opportunity, and the second opportunity identify is configured to indicate to perform an aggregated feedback for measurement reports for respective transmission exchanges corresponding to the wireless local area network sensing measurement setup identity after the second transmission opportunity;
an eighth identifier bit and a ninth identifier bit, wherein: the eighth identifier bit is configured to indicate a third opportunity identity of a third transmission opportunity: the ninth identifier bit is configured to indicate a fourth number of at least one transmission opportunity or a fourth opportunity identity of a fourth transmission opportunity, wherein the fourth number is configured to indicate to perform an aggregated feedback for measurement reports for measurement exchanges corresponding to the fourth number of at least one transmission opportunity beginning with the third transmission opportunity after an interval of the fourth number of at least one transmission opportunity from the third transmission opportunity, and the fourth opportunity identity is configured to indicate to perform an aggregated feedback for measurement reports for measurement exchanges from the third transmission opportunity to the fourth transmission opportunity after the fourth transmission opportunity.

Optionally, in an embodiment of the present disclosure, the first time information further includes a tenth identifier bit, and the tenth identifier bit is configured to indicate a phase of the transmission opportunity.

Optionally, in an embodiment of the present disclosure, the feedback unit is further configured to:
send a second message frame during a wireless local area network sensing measurement session setup procedure, wherein the second message frame includes a twelfth identifier bit, and the twelfth identifier bit is configured to indicate that the responder of sensing in wireless local area network supports a delayed feedback for the measurement report.

Optionally, in an embodiment of the present disclosure, the second message frame includes an information element of a wireless local area network sensing measurement parameter, and the information element of the wireless local area network sensing measurement parameter includes the twelfth identifier bit.

Optionally, in an embodiment of the present disclosure, the receiving unit 401 is further configured to:
receive a first trigger message, wherein the first trigger message is configured to indicate to feed back a measurement report for a first target measurement exchange; and
based on a feedback occasion of the measurement report for the first target measurement exchange, feeding back the measurement report for the first target measurement exchange.

Optionally, in an embodiment of the present disclosure, the receiving unit 401 is further configured to:
receive a second trigger message, wherein the second trigger message is configured to indicate to feed back a measurement report for a second target measurement exchange; and
based on a feedback occasion of the measurement report for the second target measurement exchange, feeding back the measurement report for the second target measurement exchange.

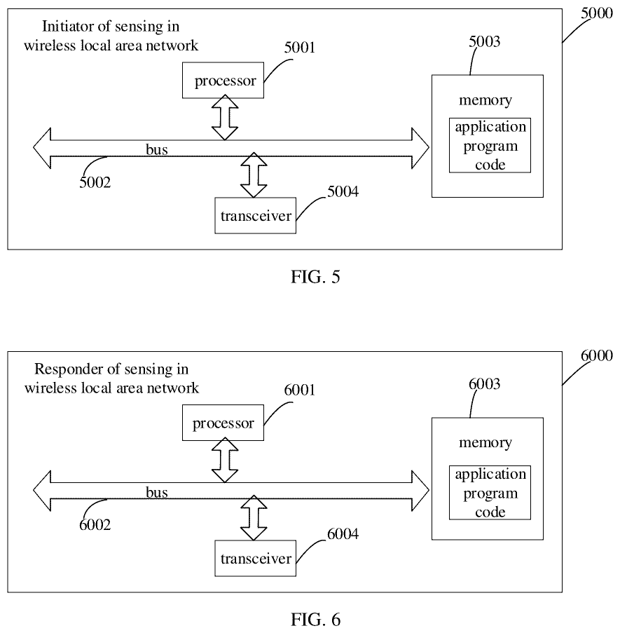

An embodiment of the present disclosure further provides an initiator of sensing in wireless local area network, as shown in FIG. 5. The initiator 5000 of sensing in wireless local area network shown in FIG. 5 may be a server, including: a processor 5001 and a memory 5003. The processor 5001 and the memory 5003 are connected, such as through a bus 5002. Optionally, the initiator 5000 of sensing in wireless local area network may further include a transceiver 5004. It should be noted that in practical applications, the number of transceivers 5004 is not limited to one, and the structure of the initiator 5000 of sensing in wireless local area network does not constitute a limitation on the embodiments of the present disclosure.

The memory 5003 is configured to store application program codes for implementing the embodiments of the present disclosure, and the processor 5001 controls the implementation. The processor 5001 is configured to execute the application program codes stored in the memory 5003 to realize the communication method applicable to the initiator of sensing in wireless local area network in the solutions of the present disclosure.

An embodiment of the present disclosure further provides a responder of sensing in wireless local area network, as shown in FIG. 6. The responder 6000 of sensing in wireless local area network shown in FIG. 6 may be a server, including: a processor 6001 and a memory 6003. The processor 6001 and the memory 6003 are connected, such as through a bus 6002. Optionally, the responder 6000 of sensing in wireless local area network may further include a transceiver 6004. It should be noted that in practical applications, the number of transceivers 5004 is not limited to one, and the structure of the responder 6000 of sensing in wireless local area network does not constitute a limitation on the embodiments of the present disclosure.

The memory 6003 is configured to store application program codes for implementing the embodiments of the present disclosure, and the processor 6001 controls the implementation. The processor 6001 is configured to execute the application program codes stored in the memory 6003 to realize the communication method applicable to the responder of sensing in wireless local area network shown in FIG. 2.

The processor 5001 and the processor 6001 may be a Central Processing Unit (CPU), a general-purpose processor, a Digital Signal Processor (DSP), an Application Specific Integrated Circuit (ASIC), or a Field Programmable Gate Array (FPGA), or other programmable logic devices, transistor logic devices, hardware components, or any combination thereof. It may implement or execute the various illustrative logical blocks, modules and circuits described based on the content of the present disclosure. The processor 5001 and the processor 6001 may also be a combination that implements computing functions, such as a combination of one or more microprocessors, a combination of a DSP and a microprocessor, etc.

The bus 5002 and the bus 6002 may include a path by which information between the above-mentioned components is transmitted. The bus 5002 and the bus 6002 may be a Peripheral Component Interconnect (PCI) bus or an Extended Industry Standard Architecture (EISA) bus, etc. The bus 5002 and the bus 6002 may be classified into an address bus, a data bus, a control bus, etc. For ease of presentation, only one thick line is used in FIG. 5 and FIG. 6, but it does not mean that there is only one bus or one type of bus.

The memory 5003 and the memory 6003 may be a Read-Only Memory (ROM) or other types of static storage devices that may store static information and instructions, a Random-Access Memory (RAM) or other types of dynamic storage devices that may store information and instructions. The memory 5003 and the memory 6003 may also be Electrically Erasable Programmable Read Only Memory (EEPROM), Compact Disc Read Only Memory (CD-ROM) or other optical disk storage, optical disk storage (including compressed Optical disc, laser disc, optical disc, digital versatile disc, Blu-ray disc, etc.), magnetic disk storage medium or other magnetic storage device, or any other medium which may be configured to carry or store the desired program codes in the form of instructions or data structures and can be accessed by a computer, and embodiments of the present disclosure are not limited to this.

An embodiment of the present disclosure provides a computer-readable storage medium. The computer-readable storage medium stores a computer program. When run on a computer, the computer may implement the corresponding content in the foregoing method embodiments.

It should be understood that although various steps in the flowchart of the accompanying drawings are shown in sequence as indicated by arrows, these steps are not necessarily performed in the order indicated by arrows. Unless explicitly stated herein, the execution of these steps is not strictly limited in order, and they can be executed in other orders. Moreover, at least some of the steps in the flowchart of the accompanying drawings may include multiple sub-steps or multiple stages. These sub-steps or stages are not necessarily executed at the same time, but may be executed at different times, and their execution order is also not necessarily need to be performed sequentially, but may be performed in turn or alternately with other steps or sub-steps of other steps or at least part of the stages.

It should be noted that the computer-readable storage medium mentioned above in the present disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of computer readable storage media may include, but are not limited to: an electrical connection having one or more conductors, a portable computer disk, a hard drive, Random Access Memory (RAM), Read Only Memory (ROM), Erasable Programmable Read-Only Memory (EPROM or flash memory), fiber optics, portable compact disk read-only memory (CD-ROM), optical storage devices, magnetic storage devices, or any suitable combination of the above. In the present disclosure, a computer-readable storage medium may be any tangible medium that contains or stores a program for use by or in connection with an instruction execution system, apparatus, or device. In the present disclosure, a computer-readable signal medium may include a data signal propagated in baseband or as part of a carrier wave, carrying computer-readable program codes therein. Such propagated data signals may take a variety of forms, including but not limited to electromagnetic signals, optical signals, or any suitable combination of the above. A computer-readable signal medium may also be any computer-readable storage medium other than a computer-readable storage medium. The computer-readable signal medium may send, propagate, or transmit programs for use by or in connection with an instruction execution system, apparatus, or device program. The program codes contained on a computer-readable storage medium may be transmitted using any suitable medium, including but not limited to: wire, optical cable, radio frequency (RF), etc., or any suitable combination of the foregoing.

The above computer-readable storage medium may be included in the above-mentioned initiator of sensing in wireless local area network: it may also exist independently without being assembled into the initiator or the responder of sensing in wireless local area network.

The computer-readable storage medium carries one or more programs. When the one or more programs are executed by the initiator or the responder of sensing in wireless local area network, the initiator or the responder of sensing in wireless local area network carries out corresponding communication methods.

According to one aspect of the present disclosure, a computer program product or computer program is provided. The computer program product or computer program includes computer instructions stored in a computer-readable storage medium. A processor of a computer device reads the computer instructions from the computer-readable storage medium, and the processor executes the computer instructions, so that the computer device carries out the communication methods provided in the above various optional implementations.

The computer program codes for performing the operations of the present disclosure may be written in one or more programming languages, including object-oriented programming languages such as Java, Smalltalk, C++, and conventional Procedural programming language-such as “C” or a similar programming language. The program codes may be executed entirely on a user computer, executed partly on the user computer, executed as a stand-alone software package, executed partly on the user computer and partly on a remote computer or executed entirely on the remote computer or server. In situations involving the remote computer, the remote computer may be connected to the user computer through any kind of network, including a Local Area Network (LAN) or a Wide Area Network (WAN), or it may be connected to an external computer (such as connected through the internet by utilizing an Internet service provider).

The flowcharts and block diagrams in the figures illustrate the architecture, functionality, and operations of possible implementations of systems, methods, and computer program products according to various embodiments of the present disclosure. In this regard, each block in the flowcharts or block diagrams may represent a module, segment, or portion of code that contains executable one or more instructions for implementing specified logical functions. It should also be noted that, in some alternative implementations, the functions noted in the blocks may occur in an order different from the order noted in the figures. For example, two blocks shown one after another may be actually executed substantially in parallel, or they may be sometimes executed in the reverse order, depending on the functionality involved. It will also be noted that each block of the block diagrams and/or flowcharts, and combinations of blocks in the block diagrams and/or flowcharts, may be implemented by special purpose hardware-based systems that perform the specified functions or operations, or may be implemented using a combination of specialized hardware and computer instructions.

The modules involved in the embodiments of the present disclosure may be implemented in software or hardware. The name of a module does not constitute a limitation on the module itself under certain circumstances. For example, module A may also be described as “module A configured to perform operation B”.

The above description is only a description of the example embodiments of the present disclosure and the technical principles applied. Those skilled in the art should understand that the disclosure scope involved in the present disclosure is not limited to technical solutions including specific combinations of the above technical features, but should also cover other technical solutions formed by any combination of the above technical features or equivalent features without departing from the concept of the present disclosure, such as a technical solution formed by replacing the above features with technical features with similar functions disclosed in the present disclosure (but not limited to this).

1. A communication method, performed by an initiator of sensing in wireless local area network, and the method comprising:
determining first time information, wherein the first time information is configured to indicate a feedback occasion of a measurement report for at least one measurement exchange; and
sending the first time information during a wireless local area network sensing measurement setup procedure.

2. The method according to claim 1, wherein in response to that a wireless local area network sensing measurement session corresponds to one transmission opportunity, the first time information comprises a first identifier bit and a second identifier bit;
wherein the first identifier bit is configured to indicate a first exchange identity of a first measurement exchange;
wherein the second identifier bit is configured to indicate a first number of at least one measurement exchange or a second exchange identity of a second measurement exchange, wherein:
the first number is configured to indicate to feed back a measurement report for the first number of at least one measurement exchange beginning with the first measurement exchange, after a Null Data Packet (NDP) frame corresponding to the first number of at least one measurement exchange beginning with the first measurement exchange is received in the transmission opportunity;
the second exchange identity is configured to indicate to feed back measurement reports for measurement exchanges from the first measurement exchange to the second measurement exchange after NDP frames corresponding to the measurement exchanges from the first measurement exchange to the second measurement exchange are received in the transmission opportunity.

3. The method according to claim 2, wherein the first time information further comprises a third identifier bit, and the third identifier bit is configured to indicate a measurement phase of each measurement exchange.

4. The method according to claim 1, wherein in response to that a wireless local area network sensing measurement session corresponds to a plurality of transmission opportunities, the first time information comprises at least one of:
a fourth identifier bit and a fifth identifier bit, wherein:
the fourth identifier bit is configured to indicate a third exchange identity of a third measurement exchange;
the fifth identifier bit is configured to indicate a second number of at least one transmission opportunity or a first opportunity identity of a first transmission opportunity, wherein the second number is configured to indicate to feed back a measurement report for the third measurement exchange after an interval of the second number of at least one transmission opportunity, and the first opportunity identity is configured to indicate to feedback back the measurement report for the third measurement exchange after the first transmission opportunity;
a sixth identifier bit and a seventh identifier bit, wherein:
the sixth identifier bit is configured to indicate a wireless local area network sensing measurement setup identity;
the seventh identifier bit is configured to indicate a third number of at least one transmission opportunity or a second opportunity identity of a second transmission opportunity, wherein the third number is configured to indicate to perform an aggregated feedback for measurement reports for respective transmission exchanges corresponding to the wireless local area network sensing measurement setup identity after an interval of the third number of at least one transmission opportunity, and the second opportunity identify is configured to indicate to perform an aggregated feedback for measurement reports for respective transmission exchanges corresponding to the wireless local area network sensing measurement setup identity after the second transmission opportunity;
an eighth identifier bit and a ninth identifier bit, wherein:
the eighth identifier bit is configured to indicate a third opportunity identity of a third transmission opportunity;
the ninth identifier bit is configured to indicate a fourth number of at least one transmission opportunity or a fourth opportunity identity of a fourth transmission opportunity, wherein the fourth number is configured to indicate to perform an aggregated feedback for measurement reports for measurement exchanges corresponding to the fourth number of at least one transmission opportunity beginning with the third transmission opportunity after an interval of the fourth number of at least one transmission opportunity from the third transmission opportunity, and the fourth opportunity identity is configured to indicate to perform an aggregated feedback for measurement reports for measurement exchanges from the third transmission opportunity to the fourth transmission opportunity after the fourth transmission opportunity.

5. The method according to claim 4, wherein the first time information further comprises a tenth identifier bit, and the tenth identifier bit is configured to indicate a phase of at least one transmission opportunity.

6. The method according to claim 1, further comprising:
sending a first message frame during a wireless local area network sensing measurement session setup procedure, wherein the first message frame comprises an eleventh identifier bit, and the eleventh identifier bit is configured to indicate that the initiator of sensing in wireless local area network supports a delayed feedback for the measurement report.

7. The method according to claim 6, wherein the first message frame comprises an information element of a wireless local area network sensing measurement parameter, and the information element of the wireless local area network sensing measurement parameter comprises the eleventh identifier bit.

8. The method according to claim 2, further comprising:
after sending an NDP frame corresponding to a first target measurement exchange, sending a first trigger message, wherein the first trigger message is configured to indicate to feed back a measurement report for the first target measurement exchange;
wherein the first target measurement exchange is the first number of at least one measurement exchange beginning with the first measurement exchange, or all measurement exchanges from the first measurement exchange to the second measurement exchange.

9. The method according to claim 4, further comprising:
after sending an NDP frame corresponding to a second target measurement exchange, sending a second trigger message, wherein the second trigger message is configured to indicate to feed back a measurement report for the second target measurement exchange;
wherein in response to that the first time information comprises the fourth identifier bit and the fifth identifier bit, the second target measurement exchange is the third measurement exchange;
wherein in response to that the first time information comprises the sixth identifier bit and the seventh identifier bit, the second target measurement exchange is respective measurement exchanges corresponding to the wireless local area network sensing measurement setup identity in the third number of at least one transmission opportunity, or respective measurement exchanges corresponding to the wireless local area network sensing measurement setup identity in the second transmission opportunity and a transmission opportunity before the second transmission opportunity;
wherein in response to that the first time information comprises the ninth identifier bit and the tenth identifier bit, the second target measurement exchange is a measurement exchange corresponding to the fourth number of at least one transmission opportunity beginning with the third transmission opportunity, or measurement exchanges corresponding to the third transmission opportunity to the fourth transmission opportunity.

10. A communication method, performed by a responder of sensing in wireless local area network, the method comprising:
receiving first time information during a wireless local area network sensing measurement setup procedure, wherein the first time information is configured to indicate a feedback occasion of a measurement report for at least one measurement exchange; and
based on the feedback occasion, feeding back the measurement report for respective measurement exchange of the at least one measurement exchange.

11. The method according to claim 10, wherein in response to that a wireless local area network sensing measurement session corresponds to a transmission opportunity, the first time information comprises a first identifier bit and a second identifier bit;
wherein the first identifier bit is configured to indicate a first exchange identity of a first measurement exchange;
wherein the second identifier bit is configured to indicate a first number of at least one measurement exchange or a second exchange identity of a second measurement exchange, wherein:
the first number is configured to indicate to feed back a measurement report for the first number of at least one measurement exchange beginning with the first measurement exchange, after a Null Data Packet (NDP) frame corresponding to the first number of at least one measurement exchange beginning with the first measurement exchange is received in the transmission opportunity;
the second exchange identity is configured to indicate to feed back measurement reports for measurement exchanges from the first measurement exchange to the second measurement exchange after NDP frames corresponding to the measurement exchanges from the first measurement exchange to the second measurement exchange are received in the transmission opportunity.

12. The method according to claim 11, wherein the first time information further comprises a third identifier bit, and the third identifier bit is configured to indicate a measurement phase of each measurement exchange.

13. The method according to claim 10, wherein in response to that a wireless local area network sensing measurement session corresponds to a plurality of transmission opportunities, the first time information comprises at least one of:
a fourth identifier bit and a fifth identifier bit, wherein:
the fourth identifier bit is configured to indicate a third exchange identity of a third measurement exchange;
the fifth identifier bit is configured to indicate a second number of at least one transmission opportunity or a first opportunity identity of a first transmission opportunity, wherein the second number is configured to indicate to feed back a measurement report for the third measurement exchange after an interval of the second number of at least one transmission opportunity, and the first opportunity identity is configured to indicate to feedback back the measurement report for the third measurement exchange after the first transmission opportunity;
a sixth identifier bit and a seventh identifier bit, wherein:
the sixth identifier bit is configured to indicate a wireless local area network sensing measurement setup identity;
the seventh identifier bit is configured to indicate a third number of at least one transmission opportunity or a second opportunity identity of a second transmission opportunity, wherein the third number is configured to indicate to perform an aggregated feedback for measurement reports for respective transmission exchanges corresponding to the wireless local area network sensing measurement setup identity after an interval of the third number of at least one transmission opportunity, and the second opportunity identify is configured to indicate to perform an aggregated feedback for measurement reports for respective transmission exchanges corresponding to the wireless local area network sensing measurement setup identity after the second transmission opportunity;
an eighth identifier bit and a ninth identifier bit, wherein:
the eighth identifier bit is configured to indicate a third opportunity identity of a third transmission opportunity;
the ninth identifier bit is configured to indicate a fourth number of at least one transmission opportunity or a fourth opportunity identity of a fourth transmission opportunity, wherein the fourth number is configured to indicate to perform an aggregated feedback for measurement reports for measurement exchanges corresponding to the fourth number of at least one transmission opportunity beginning with the third transmission opportunity after an interval of the fourth number of at least one transmission opportunity from the third transmission opportunity, and the fourth opportunity identity is configured to indicate to perform an aggregated feedback for measurement reports for measurement exchanges from the third transmission opportunity to the fourth transmission opportunity after the fourth transmission opportunity.

14. The method according to claim 13, wherein the first time information further comprises a tenth identifier bit, and the tenth identifier bit is configured to indicate a phase of the transmission opportunity.

15. The method according to claim 10, further comprising:
sending a second message frame during a wireless local area network sensing measurement session setup procedure, wherein the second message frame comprises a twelfth identifier bit, and the twelfth identifier bit is configured to indicate that the responder of sensing in wireless local area network supports a delayed feedback for the measurement report.

16. The method according to claim 15, wherein the second message frame comprises an information element of a wireless local area network sensing measurement parameter, and the information element of the wireless local area network sensing measurement parameter comprises the twelfth identifier bit.

17. The method according to claim 11, further comprising:
receiving a first trigger message, wherein the first trigger message is configured to indicate to feed back a measurement report for a first target measurement exchange; and
based on a feedback occasion of the measurement report for the first target measurement exchange, feeding back the measurement report for the first target measurement exchange.

18.-20. (canceled)

21. An initiator of sensing in wireless local area network, comprising:
a processor; and
a memory storing a computer program executable by the processor,
wherein the processor is configured to:
determine first time information, wherein the first time information is configured to indicate a feedback occasion of a measurement report for at least one measurement exchange; and
send the first time information during a wireless local area network sensing measurement setup procedure.

22. A responder of sensing in wireless local area network, comprising:
a processor; and
a memory storing a computer program executable by the processor,
wherein the processor is configured to perform the method according to claim 10.

23. A non-transitory computer-readable storage medium storing a computer program that, when executed by a processor, causes the processor to perform the method according to claim 1.
